(19) United States
(12) Patent Application Publication
(10) Pub. No.: US 2005/0092384 A1
(43) Pub. Date: May 5, 2005

(54) Semi-flexible air duct

(75) Inventors: Stanley Allen Curb, Dickensen, TX (US); Lynda Mae Kornbleet, Houston, TX (US)

Correspondence Address: ELIZABETH R. HALL, 1722 MARYLAND STREET, HOUSTON, TX, 77006, US

(73) Assignee: Superior Air Ducts, Houston, TX (US)

(21) Appl. No.: 10/974,180

(22) Filed: Oct. 27, 2004

Related U.S. Application Data
(60) Provisional application No. 60/515,261, filed on Oct. 29, 2003.

(51) Int. Cl. F16L 9/14; B31F 1/22; B31F 1/32

(52) U.S. Cl. 138/140

(57) ABSTRACT

A semi-flexible air duct comprising an inner layer of fibrous material reinforced by a support member to provide a continuous bore for the air duct; an insulation layer of cellulose-based material surrounding the inner layer and an outer layer surrounding the insulation layer.

### CROSS REFERENCE TO RELATED APPLICATIONS

This application claims priority to pending U.S. Patent Application Ser. No. 60/515,261 (Attorney Docket Number KORN-P001V), filed Oct. 29, 2003 by Stanley Curb, et al. and entitled “Semi-Flexible Air Duct.”

### BACKGROUND OF THE INVENTION

1. Field of the Invention

The present invention relates to a duct for gas transfer. In particular, the present invention relates to a heat and noise insulating duct utilized for conveying hot or cold air in heating and air conditioning systems.

2. Description of the Related Art

Air conditioning systems for heating and/or cooling air are typically provided with cooling and heating equipment by which ambient air is heated or cooled depending upon the particular need. The heated or cooled air is then forced by an air handler of some type through air ducting for distribution to areas where needed, e.g. the rooms of a residence or building.

Conventional air ducts are generally formed by helically winding a heat insulative material around an outer circumference of the air flow passageway. Such air ducts typically have an inner liner of polyethylene or other plastic reinforced by a spirally wound coil member to form and support the air flow passageway. Surrounding the inner liner is a layer of heat insulative material that provides resistance to heat transfer. The term R-value refers to this resistance to heat transfer between the conditioned air passing through the ducting and the unconditioned or ambient air surrounding the ducting. Fiberglass batting is the most common insulative material used; however, recently natural fibrous materials, such as described in U.S. Pat. No. 6,425,419, have begun to replace fiberglass batting. The inner and insulative layers are typically surrounded and protected by a dark plastic sheathing.

Air ducts are insulated to prevent heat transfer between the air flowing through the ducting and the ambient air surrounding the ducting. The common use of fiberglass batting in the insulative layer raises significant safety and health issues. OSHA requires workers handling fiberglass insulation materials to wear protective clothing and respirator masks for protection from the fiberglass particles that break loose during handling.

Since fiberglass has been identified as a possible carcinogen, it is very important that fiberglass particles do not enter the air being distributed through the air ducts. Although air ducts have an inner liner of plastic and spiraled wire, the plastic is often punctured or torn by technicians installing, servicing or cleaning an air conditioning system. If the inner plastic liner is punctured, loose fibers of glass from the fiberglass batting insulation may be dislodged into the flowing air and distributed throughout the system particularly under conditions of increased air flow pressure.

Currently available air ducts are typically 6-8 inches in internal diameter and 8-12 inches in external diameter. These air ducts are too large to fit through walls of a building that are typically separated by 2×4 studs. Air ducts have not been made smaller because as the inner diameter of the air duct decreases, the air velocity of the air flowing through the air flow passageway substantially increases. Whenever the air velocity in the air flow passageway is increased, the plastic liner is likely to be ruptured and the insulation layer of the air duct torn apart by the force of the high velocity air. If the insulation layer is made of fiberglass the glass fibers blown through the system create a significant health hazard. Even is the insulation layer is made of a non-hazardous natural fiber, the breakdown and tearing of the insulative layer negates the resistance to heat transfer provided by the insulative layer.

Furthermore, air ducts act as a conduit for noise generated by an air blowing source such as an air blower. The noise is distributed throughout the residence or business often causing the discomfort or irritation of occupants. This is particularly true if the air duct is reduced in size such that the velocity of the air flow is increased.

Air ducts made of better materials that are healthier, quieter and more efficient are needed.

### SUMMARY OF THE INVENTION

The present invention provides a semi-flexible air duct capable of withstanding high velocity air flow. One embodiment has an inner made liner of a porous fibrous material and supported by a spirally wrapped coil member. The porous fibrous material attenuates the noise generated from an air blower and the high velocity air flow, as well as being more resilient to the destructive nature of high velocity air flow.

One aspect of the present invention is an air duct for air conditioning and heating systems comprising: (a) an inner layer providing a continuous bore for the air duct, the inner layer having an inner liner of porous fibrous material, an external liner, and a support member embedded between and bonded to the inner liner and the external liner; (b) an insulation layer of plant-derived fibrous material surrounding the inner layer; and (c) an outer layer surrounding the insulation layer for protecting the air duct.

Another aspect of the present invention is an air duct for air conditioning and heating systems comprising: (a) an inner layer providing a continuous bore for the air duct, the inner layer having an inner liner, an external liner, and a support member embedded between and bonded to the inner liner and the external liner; (b) an insulation layer of plant-derived fibrous material surrounding the inner layer; and (c) an outer layer surrounding the insulation layer for protecting the air duct, the outer layer comprising a mesh material sandwiched between an upper and a lower tape wrap.

Yet another aspect of the present invention is a heat-insulating, noise-reducing air duct comprising: (a) an inner layer providing a continuous bore for the air duct, the inner layer having an inner liner composed of a porous cellulose-containing material, an external liner, and a spirally wound coil member positioned between the inner liner and the external liner; (b) an insulation layer, a principal ingredient of the insulation layer being cellulose, wherein the insulation layer surrounds the inner layer; and (c) an outer layer surrounding the insulation layer for protecting the air duct, wherein the exterior surface of the outer layer is reflective.

Still yet another aspect of the present invention is an air duct suitable for incorporation into the walls of buildings and residences, the air duct comprising: (a) an inner layer providing a continuous bore for an air duct, the inner layer having an inner liner, an external liner, a spirally wound metallic coil member positioned between the inner liner and the external liner, and an adhesive for adhering the inner liner, the external liner and the coil member together; (b) an insulation layer of a plant derived material surrounding the inner layer, the insulation layer having a density of at least 2.0 pounds per cubic inch; and (c) an outer layer surrounding the insulation layer for protecting the air duct, the outer layer comprising a mesh material sandwiched between an upper and a lower tape wrap.

Additional features and advantages of the invention will be described hereinafter which form the subject of the claims of the invention. It should be appreciated by those skilled in the art that the conception and the specific embodiments disclosed might be readily utilized as a basis for modifying or redesigning the method or process for carrying out the same purposes as the invention. It should be realized that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an oblique view of an air duct having an inner layer, an insulation layer and an outer layer where each layer is stripped away from the end of the air duct;

FIG. 2 shows a partial cross-sectional view of the air duct of the present invention;

FIG. 3 is a cross-sectional view of the overlapping of the insulation layer of the prior art; and

FIG. 4 is a cross-sectional view of the insulation layer of the present invention having mateable sides to provide a non-overlapping continuous insulation layer.

### DESCRIPTION OF THE ILLUSTRATIVE EMBODIMENTS

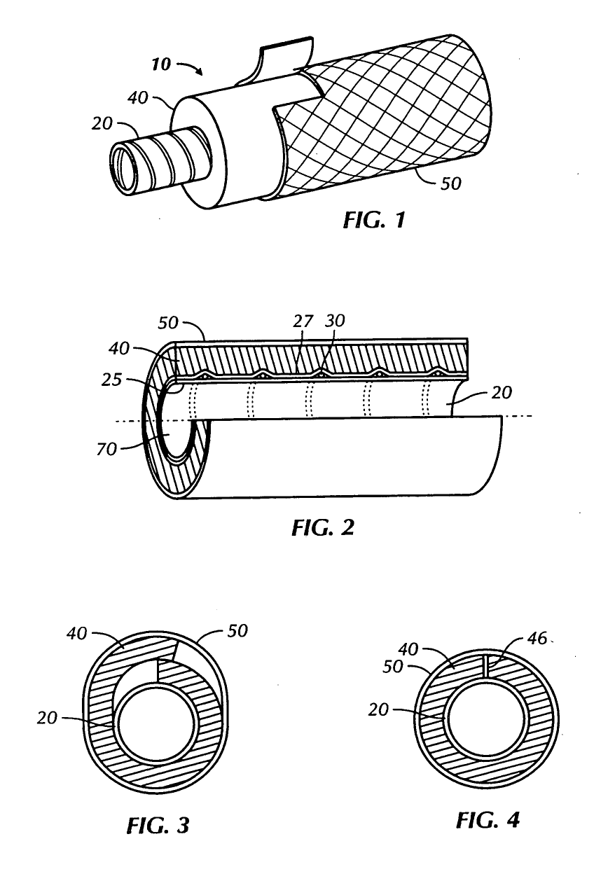

The present invention provides a semi-flexible air duct 10 having an inner layer 20, an insulation layer 40 and an outer layer 50. FIG. 1 shows the layers sequentially stripped away from the end of the air duct.

As illustrated in FIG. 2, the inner layer 20 is made of an inner liner 25, a support member 30, and an external liner 27. The inner lining 25, the external lining 27 and the support member 30 are joined together using an adhesive. Preferably an environmentally friendly flame retardant, flame resistant adhesive is used. In addition, the adhesive usually contains borate that resists fungal growth. The adhesive may be an epoxy or a pressure-, heat- or uv-activated adhesive. Furthermore, the inner layer 20 may be treated with a water resistant material.

In the present invention either the inner lining 25, the external lining 27, or both the inner lining 25 and the external lining 27 are preferably made of a fibrous, or porous, material reinforced by the support member 30 to provide structural integrity to the air flow passageway 70. Although nylon (or some other synthetic material) may be used as the inner or external lining of the inner layer 20, natural plant-derived materials such as paper, hemp, flax, cotton, kapok, and jute are preferred. The major component of these plant-derived materials is cellulose.

Typically the inner lining 25 and/or the external lining 27 is made of fibrous material that is porous and permeable to air, as for example a cotton gauze material, or a strong smooth layer of linen or paper stock. Preferably the inner lining 25 is made of a porous material. As the porosity of the inner lining 25 increases, the ability of the air duct 10 to dampen or attenuate the noise generated by air blowers and high velocity air flow is enhanced. This strong layer of porous fibrous material that makes up the inner lining 25 is not destroyed by high pressure, high velocity air flowing through the air flow passageway.

Although the inner lining 25 is preferably made of a porous natural fiber, the external lining 27 may be made of a wide variety of material made from synthetic or natural fibers. The inner and external linings may be made of the same material or of different materials. For example, the porosity of the external lining may be less than the porosity of the inner lining.

The support member 30 is made of a strong material, such as the spirally wound coil member shown in FIG. 2. The support member 30 provides structural integrity to the inner layer 20 and prevents the collapse of the air duct into the air flow passageway 70. The support member 30 is typically embedded between the inner lining 25 and the external lining 27 of the inner layer 20.

The support member 30 is made of a non-corrosive, non-rusting material including without limitation an elastomeric material such as a rubber-based cord or mesh, a silicon material such as a fiber optic wire, a plastic material such as a WEED EATER cord, a paper material such as a cardboard, or a metallic material such as aluminum, a bronze or zinc-coated metal, or a galvanized metal. The support member 30 may take a variety of forms such as a round wire, flat strips of material, an interwoven support mesh, or a tubular structure.

One embodiment of the present invention uses a metallic coil member having the centers of adjacent spirals of the coil member spaced from about 0.25 inches to about 1.5 inches apart and will preferably be less that 1.0 inches apart. The spirals are made closer together for smaller air ducts that will have to withstand an increased pressure from the increased velocity of the air flowing through the air passageway. The support member 30 of currently available air ducts is a metallic coil having a distance between the centers of adjacent spirals of the coil at about 1.5-2.0 inches apart.

One or more layers of insulation 40 surround the inner lining to provide thermal insulation of the air flowing through the air passageway from ambient air. In the present invention, the insulation layer 40 is preferably a layer of plant-derived fibrous material that takes the place of the typical fiberglass batting material of prior art. The preferred material is cotton. However, any suitable cellulose based material may be used, such as hemp, flax, cotton, kapok, jute, and combinations of such materials. The cotton batting (or other natural fibers) are preferably treated with a borate-containing fire retardant with flame resistant properties.

One advantage of the natural fiber batting insulation is that it is non-hazardous and non-carcinogenic. In addition, the natural fiber batting has greater insulating properties than the fiberglass batting insulation. For example, a typical cotton batting having a density of about 1.85 pounds/cubic foot has an R-value of 3.6 per inch of thickness for cotton as compared to fiberglass that has an R-value 2.5 per inch of thickness. An R-value defines the resistance to heat transfer and is a numeric value expressed in units of hr/Btu-ft.² /F°.

Preferred embodiments of the present invention do not use normal cotton batting, but use a special order cotton batting having a density greater than 2.0 pounds/foot³. Commonly available cotton batting has a maximum density of about 1.85 pounds/cubic foot. A preferred insulation in the present invention is a cotton batting having a 2.2 pound/foot³ density. The higher density cotton batting is used because it resists being pulled apart by high velocity air flow and provides significantly higher R-values. In contrast, air ducts made with an insulation layer of cotton batting having less than a 2.0 pound/inch³ density are subject to being pulled apart by high velocity air flow.

Currently the insulation layer 40 of air ducts must be overlapped at least 1½ inches as shown in FIG. 3 to meet the requirement for UL 181 testing. However, the use of a high-density cotton batting allows the insulation layer 40 not to be overlapped. For example, FIG. 4 shows the use of a single layer of insulation batting that is joined together at the sides without overlapping. The two sides are preferably held together by the outer layer 50 that securely surrounds the insulation layer 40. Tape, hog rings, or some other joining mechanism may also be used to hold the insulation layer 40 together. Using the high density cotton batting means that the air ducts will meet the requirements for UL 181 testing without being overlapped. Such joining methods for the insulation layer saves insulation batting material and allows the outside diameter of the air duct to be much smaller.

The air duct 10 of the present invention has an outer layer 50 that surrounds and protects the other components of the air duct 10. Prior art sheathing, or the outer layer 50, is typically formed from black polyethylene, or coated fiberglass. A preferred embodiment of the outer layer 50 of the present invention uses a strong mesh material, sandwiched between an upper and a lower tape wrap. More specifically, the inner tape wrap has a heat-activated adhesive on the external surface facing the mesh such that when the outer tape wrap is positioned above the mesh and heat applied the two tape wraps are adhered together and the mesh is sandwiched in between. In addition, the external surface of the outer tape wrap is covered with a high refractive index material to prevent external heat from being absorbed by the air duct. A suitable tape for the outer tape wrap of the outer layer 50 is a Mylar tape having a reflective metalized outer surface. Alternatively, a single stainless steel or aluminum tape wrap may be used as the outer layer 50. Such tapes provide an extremely tough, durable, water-resistant, heat-resistant protection that is flexible and stable to ultra-violet rays.

Another embodiment of the present invention uses an outer layer 50 composed of a plant-derived or synthetic material. For example, nylon (or some other synthetic material) may be used as the outer layer 50 or natural plant-derived materials such as paper, hemp, flax, cotton, kapok, and jute may be used as for example a strong smooth layer of linen or paper stock.

The present invention includes an air duct having a small external diameter (e.g., from about 1.0 to about 2.0 inches in internal diameter and from about 1.5 inches to about 4 inches in outer diameter) that can fit into the walls of buildings. The air duct 10 of the present invention allows smaller air ducts to be used because of the use of an inner layer 20 having a porous fibrous material liner, a spirally coiled member with the spirals less than about one inch apart, and an insulation layer of high density cotton batting surrounding the inner layer without requiring the insulation layer to be overlapped. The air duct of the present invention is highly insulated and stable to high velocity air flow.

While preferred embodiments of the invention have been described herein, many variations thereof will be apparent to those skilled in the art without departing from the spirit of the invention. Accordingly, it is intended that the scope of the invention be limited only by the claims which follow.

1. An air duct for air conditioning and heating systems comprising:
(a) an inner layer providing a continuous bore for the air duct, the inner layer having
(i) an inner liner of porous fibrous material,
(ii) an external liner, and
(iii) a support member embedded between and bonded to the inner liner and the external liner;
(b) an insulation layer of plant-derived fibrous material surrounding the inner layer; and
(c) an outer layer surrounding the insulation layer for protecting the air duct.

2. The air duct of claim 1, wherein the inner liner comprises one or more of the following materials: paper, cotton, flax, hemp, kapok, and jute.

3. The air duct of claim 1, wherein the external liner of the inner layer comprises one or more of the following materials: paper, cotton, flax, hemp, kapok, and jute.

4. The method of claim 1, wherein the inner liner and external liner are made of the same material.

5. The air duct of claim 1, wherein an adhesive bonds the inner liner, the coil member and the external liner together.

6. The air duct of claim 1, wherein the inner layer is treated with a flame resistant material.

7. The air duct of claim 6, wherein the flame resistant material contains borate.

8. The air duct of claim 1, wherein the inner layer is treated with a water resistant material.

9. The air duct of claim 1, wherein the support member comprises a wire, a flat strip of material, a tube, or an interwoven mesh.

10. The air duct of claim 1, wherein the support member is made of a rubber-based material, a silicon material, a plastic material, a paper material, or a metallic material.

11. The air duct of claim 1, wherein the support member is a coiled metallic wire.

12. The air duct of claim 11, wherein the support member has a plurality of wraps separated by a distance less than or equal to one inch.

13. The air duct of claim 1, wherein the insulation layer comprises one or more of the following materials: cotton, flax, hemp, kapok, and jute.

14. The air duct of claim 1, wherein the insulation layer comprises a single sheet of insulative material, the sheet having a first and second side along a length of the sheet, wherein the first side abuts the second side and is held together by the outer layer.

15. The air duct of claim 1, wherein the insulation layer is made of a cotton batting having a density greater than 2.0 pounds per cubic inch.

16. The air duct of claim 1, wherein the outer layer comprises a tape having an exterior surface with a high refractive index.

17. The air duct of claim 1, wherein the outer layer comprises a flexible tape that is water-resistant, heat-resistant, and stable to ultra-violet rays.

18. The air duct of claim 1, wherein the outer layer comprises a mesh material sandwiched between an upper and a lower tape wrap.

19. The air duct of claim 18, wherein the upper tape wrap has an adhesive on a bottom surface facing the mesh material or the lower tape wrap has an adhesive on an upper surface facing the mesh material.

20. The air duct of claim 19, wherein the adhesive is heat-activated.

21. The air duct of claim 1, wherein the outer layer is made of a plant-derived material.

22. The air duct of claim 1, wherein the outer layer is made of a synthetic material.

23. The air duct of claim 1, wherein an external diameter of the duct is about 1.5 to about 4.0 inches.

24. An air duct for air conditioning and heating systems comprising:
(a) an inner layer providing a continuous bore for the air duct, the inner layer having
(iv) an inner liner,
(v) an external liner of porous fibrous material, and
(vi) a support member embedded between and bonded to the inner liner and the external liner;
(b) an insulation layer of plant-derived fibrous material surrounding the inner layer; and
(c) an outer layer surrounding the insulation layer for protecting the air duct.

25. An air duct for air conditioning and heating systems comprising:
(a) an inner layer providing a continuous bore for the air duct, the inner layer having
(vii) an inner liner,
(viii) an external liner, and
(ix) a support member embedded between and bonded to the inner liner and the external liner;
(b) an insulation layer of plant-derived fibrous material surrounding the inner layer; and
(c) an outer layer surrounding the insulation layer for protecting the air duct, the outer layer comprising a mesh material sandwiched between an upper and a lower tape wrap.

26. The air duct of claim 25, wherein the inner liner comprises one or more of the following materials: paper, cotton, flax, hemp, kapok, and jute.

27. The air duct of claim 25, wherein the external liner of the inner layer comprises one or more of the following materials: paper, cotton, flax, hemp, kapok, and jute.

28. The method of claim 25, wherein the inner liner and external liner are made of the same material.

29. The air duct of claim 25, wherein an adhesive bonds the inner liner, the coil member and the external liner together.

30. The air duct of claim 25, wherein the inner layer is treated with a flame resistant material.

31. The air duct of claim 25, wherein the inner layer is treated with a water resistant material.

32. The air duct of claim 25, wherein the support member comprises a wire, a flat strip of material, a tube, or an interwoven mesh.

33. The air duct of claim 25, wherein the support member is made of a rubber-based material, a silicon material, a plastic material, a paper material, or a metallic material.

34. The air duct of claim 25, wherein the support member is a coiled metallic wire.

35. The air duct of claim 34, wherein the support member has a plurality of wraps separated by a distance less than or equal to one inch.

36. The air duct of claim 25, wherein the insulation layer comprises one or more of the following materials: cotton, flax, hemp, kapok, and jute.

40. The air duct of claim 25, wherein the insulation layer comprises a single sheet of insulative material, the sheet having a first and second side along a length of the sheet, wherein the first side abuts the second side and is held together by the outer layer.

41. The air duct of claim 25, wherein the insulation layer is made of a cotton batting having a density greater than 2.0 pounds per cubic inch.

42. The air duct of claim 25, wherein an exterior surface of the upper tape wrap has a high refractive index.

43. The air duct of claim 25, wherein the outer layer is water-resistant, heat-resistant, and stable to ultra-violet rays.

44. The air duct of claim 25, wherein the upper tape wrap has an adhesive on a bottom surface facing the mesh material or the lower tape wrap has an adhesive on an upper surface facing the mesh material.

45. The air duct of claim 44, wherein the adhesive is heat-activated.

46. The air duct of claim 25, wherein the upper tape wrap or the lower tape wrap is made of a plant-derived material.

47. The air duct of claim 25, wherein the upper tape wrap or the lower tape wrap is made of a synthetic material.

48. The air duct of claim 25, wherein an external diameter of the duct is about 1.5 to about 4.0 inches.

49. A heat-insulating, noise-reducing air duct comprising:
(a) an inner layer providing a continuous bore for the air duct, the inner layer having
(i) an inner liner composed of a porous cellulose-containing material,
(ii) an external liner, and
(iii) a spirally wound coil member positioned between the inner liner and the external liner;
(b) an insulation layer, a principal ingredient of the insulation layer being cellulose, wherein the insulation layer surrounds the inner layer; and
(c) an outer layer surrounding the insulation layer for protecting the air duct, wherein the exterior surface of the outer layer is reflective.

50. An air duct suitable for incorporation into the walls of buildings and residences, the air duct comprising:
(a) an inner layer providing a continuous bore for an air duct, the inner layer having
(i) an inner liner,
(ii) an external liner,
(iii) a spirally wound metallic coil member positioned between the inner liner and the external liner, and
(iv) an adhesive for adhering the inner liner, the external liner and the coil member together;
(b) an insulation layer of a plant derived material surrounding the inner layer, the insulation layer having a density of at least 2.0 pounds per cubic inch; and
(c) an outer layer surrounding the insulation layer for protecting the air duct, the outer layer comprising a mesh material sandwiched between an upper and a lower tape wrap.

51. The air duct of claim 50, wherein the inner liner comprises one or more of the following materials: paper, cotton, flax, hemp, kapok, and jute.

52. The air duct of claim 50, wherein the external liner of the inner layer comprises one or more of the following materials: paper, cotton, flax, hemp, kapok, and jute.

53. The method of claim 50, wherein the inner liner and external liner are made of the same material.

54. The air duct of claim 50, wherein an adhesive bonds the inner liner, the coil member and the external liner together.

55. The air duct of claim 50, wherein the inner layer is treated with a flame resistant material.

56. The air duct of claim 50, wherein the inner layer is treated with a water resistant material.

57. The air duct of claim 50, wherein the coil member has a plurality of wraps separated by a distance less than or equal to one inch.

58. The air duct of claim 50, wherein the insulation layer comprises one or more of the following materials: cotton, flax, hemp, kapok, and jute.

59. The air duct of claim 50, wherein the insulation layer comprises a single sheet of insulative material, the sheet having a first and second side along a length of the sheet, wherein the first side abuts the second side and is held together by the outer layer.

60. The air duct of claim 50, wherein the upper tape wrap has an adhesive on a bottom surface facing the mesh material or the lower tape wrap has an adhesive on an upper surface facing the mesh material.

61. The air duct of claim 60, wherein the adhesive is heat-activated.

62. The air duct of claim 50, wherein the upper tape wrap or the lower tape wrap is made of a plant-derived material.

63. The air duct of claim 50, wherein the upper tape wrap or the lower tape wrap is made of a synthetic material.

64. The air duct of claim 50, wherein an external diameter of the duct is about 1.5 to about 4.0 inches.
